(19) United States
(12) Patent Application Publication
(10) Pub. No.: US 2009/0002497 A1
(43) Pub. Date: Jan. 1, 2009

(54) Digital Camera Voice Over Feature

(76) Inventor: Joel C. Davis, St. Cloud, FL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 11/771,771

(22) Filed: Jun. 29, 2007

(51) Int. Cl. H04N 5/225; G10L 15/26

(52) U.S. Cl. 348/207.99; 704/235; 704/E15.043; 348/E05.001

(57) ABSTRACT

Embodiments of the invention provide a method and system for adding voice and text annotations to a digital photograph. Embodiments include recording a digital photographer's voice while capturing a digital photograph. The voice recording is saved to camera memory and mapped to the digital photograph. In addition, a voice recognition function creates a text file from the voice recording and saves it to camera memory. Embedded camera software also maps the text file to the captured digital photograph.

### BACKGROUND OF THE INVENTION

Various industries require digital photography as a tool or resource for its business. For example, real estate sales require real estate agents to digitally photograph different parts of a home for sale. Another example is the insurance industry, where insurance adjustors may digitally photograph an accident scene to fill a customer claim. Still another example is in law enforcement, where criminal forensic investigators may digitally photograph crime scenes and catalog them as evidence. There are many industries that have similar needs for digital photography (e.g. real estate development, real estate appraising, general contracting, outdoor advertising, health care, law enforcement, etc.).

These industries also have the need for annotating digital photographs for future use. The notes for the picture may include dimensions of a room, address of a building, or cataloging contents of a picture. Traditionally, digital photographers manually write notes to annotate digital photographs. This is a cumbersome and time consuming process that distracts the photographer from her business purpose (i.e. photographing a home for sale, an accident site, a crime scene, etc.). Further, handwritten notes create tedious work to organize them to the corresponding digital photographs. For example, an insurance adjustor or a criminal forensic investigator may take several of photographs and corresponding several pages of notes. Organizing relevant notes to each photograph is a tedious process.

Therefore, there is a need for creating a more efficient way to annotate digital photographs.

### BRIEF SUMMARY OF THE INVENTION

Embodiments of the invention provide a method and system for adding voice and text annotations to a digital photograph. Embodiments include recording a digital photographer's voice while capturing a digital photograph. The voice recording is saved to camera memory and mapped to the digital photograph. In addition, a voice recognition function creates a text file from the voice recording and saves it to camera memory. Embedded camera software also maps the text file to the captured digital photograph.

### BRIEF DESCRIPTION OF THE SEVERAL VIEWS OF THE DRAWINGS

FIG. 1 illustrates a general overview of a system contemplated by an exemplary implementation;

FIG. 2 illustrates a functional block diagram of a system contemplated by an exemplary implementation;

FIG. 3 is a flow diagram illustrating a method of annotating digital photographs, in accordance with an exemplary implementation;

FIG. 4 is a flow diagram illustrating a method of annotating digital photographs, in accordance with an exemplary implementation; and

FIG. 5 is a flow diagram illustrating a method of annotating digital photographs, in accordance with an exemplary implementation.

### DETAILED DESCRIPTION OF THE INVENTION

Various industries require digital photography as a tool or resource for its business. For example, real estate sales require real estate agents to digitally photograph the different parts of a home for sale. These industries have a further need for annotating the digital photographs for future use. Embodiments of the present inventions allow a digital photographer to record her voice to annotate captured digital photographs.

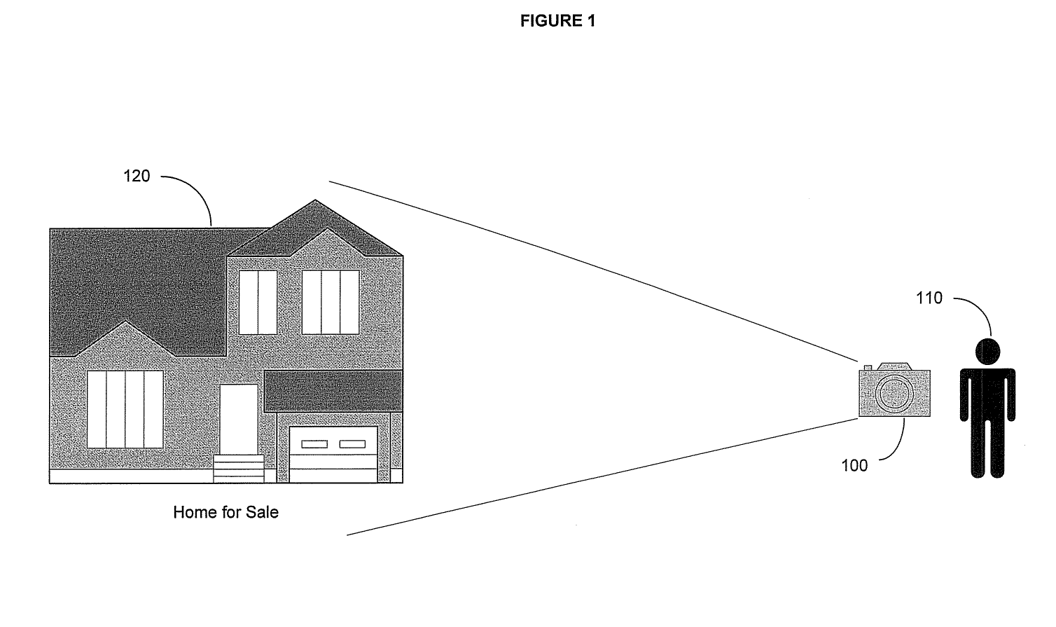

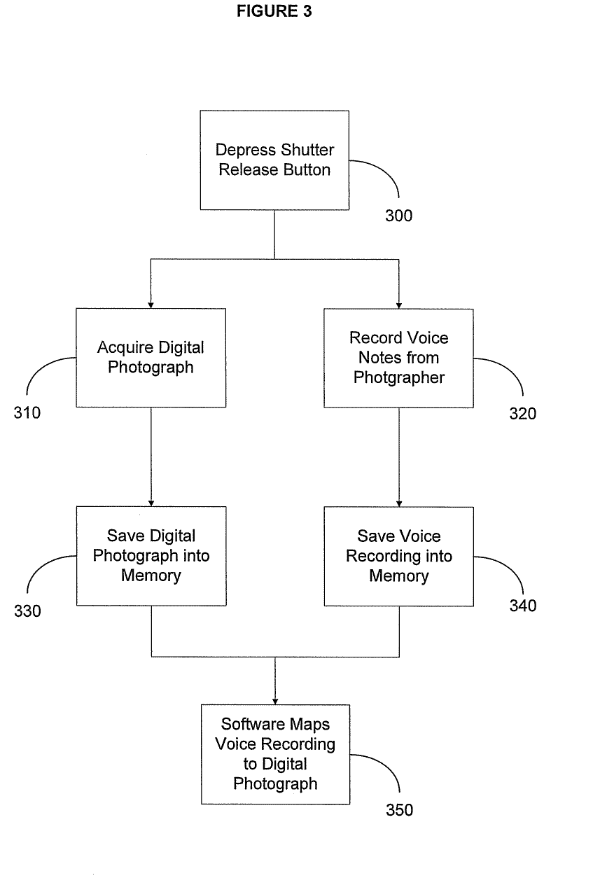

FIG. 1 illustrates an embodiment of the invention where a real estate agent 110 may be photographing a home for sale 120 with a digital camera 100. Further, the real estate agent 110 may need to annotate the digital photograph with details of the home such as its square footage, acreage, address, assessed taxes, home owner information, etc. Embodiments of the present invention would record the real estate agent's voice and annotate it to a photograph taken by the real estate agent 110. Details of the recording and annotation process will be provided when discussing FIGS. 3-5.

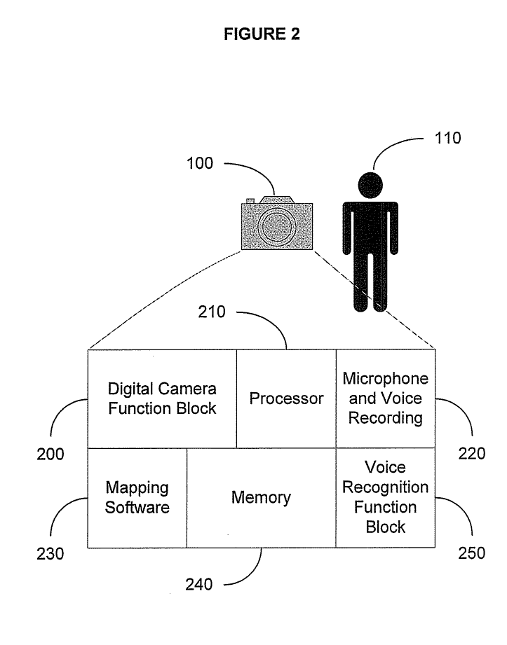

FIG. 2 illustrates a functional block diagram of a system contemplated by an exemplary implementation. A digital camera 100 contains several functional components. These may include, but are not limited to, a digital camera functional block 200, a processor 210, a microphone and voice recording function 220, mapping software 230, memory 240, and a voice recognition functional block 250. The digital camera functional block 200 performs traditional digital camera functions such as focus, flash, resolution, etc. Of course, these functions are only exemplary, and embodiments of the digital camera function block are not limited to these functions, nor may they implement all such functions. A processor 210 implements and coordinates the functions of the digital camera 100. It may allow the user to configure the digital camera functional block 200 with certain parameters such as resolution, flash, focus, etc. It may also save digital photograph, voice recordings, or text files into memory 240. Further, a processor may carry out instructions from the mapping software 230 to link and organize voice recordings to digital photographs. A microphone and voice recording functional block 220 allows the camera to record a digital photographer's voice while she captures a digital photograph. The voice recording may be stored as a WAV (Waveform audio format) file, or in any other format that would be capable of annotating a digital photograph. Mapping software 230 links and organizes the captured digital photograph to the voice recording such that when the digital photograph is subsequently viewed, the voice recording will be played simultaneously. Digital photographs and voice recordings may be stored in a digital camera's memory 240. The memory 240 may be of different types that may include, but are not limited to, SecureDigital (SD), CompactFlash (CF), SONY Memory stick, xD-Picture Card, USB flash memory drive, SmartMedia, MiniCard, or any other comparable memory card that may be used with a digital camera. A voice recognition function block analyzes the voice recording, translates the voice into text, and then stores the text in a text file that can be read by a word processor or any other text viewer. The text file is saved into memory 240 and linked to the corresponding digital photograph using the mapping software 230. The voice recognition function block need not be real time, but may be near real time such that the voice recognition text file is produced before the next digital photograph is captured by the digital photographer.

FIGS. 3-5 illustrate flow diagrams of embodiments of the present invention. In FIG. 3, at stage 300, a shutter release button is pressed. At stage 310, the digital camera 100 acquires or captures the digital photograph. Simultaneously, at stage 320, the digital camera 100 records voice annotations of the captured digital photograph from the photographer. At stages 330 and 340, the processor 210 saves both the digital photograph and the voice recording into memory 240. At stage 350, mapping software 230 links the voice recording to the corresponding digital photograph. The steps illustrated in FIG. 3 are completed before the shutter release button is pressed again to capture the next digital picture by the photographer.

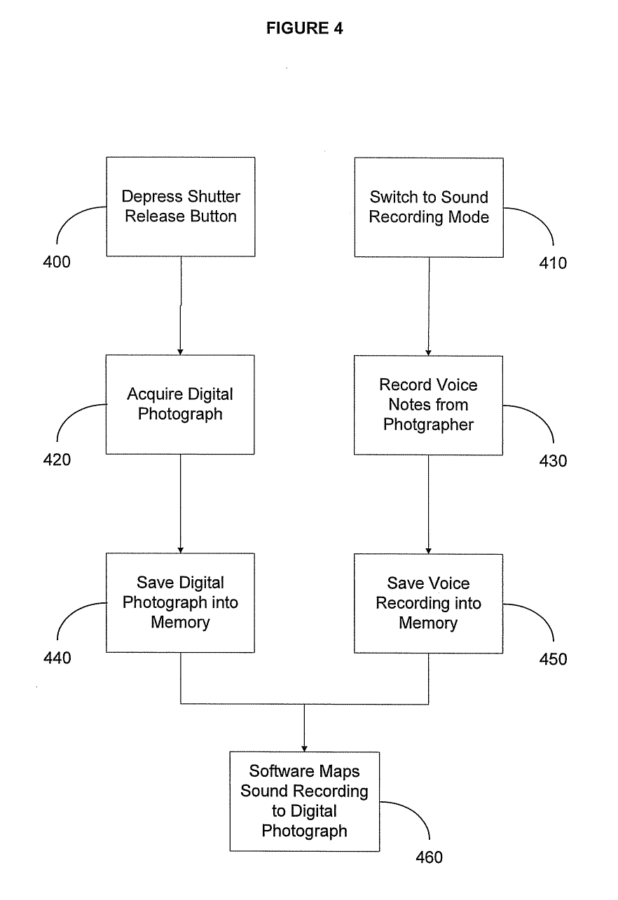

FIG. 4 illustrates another embodiment of the present invention where the voice recording function is decoupled from pressing the shutter release button. Instead, a digital camera 100 may be able to switch to a sound recording mode through a toggle switch, button, touch screen, or some other similar switching device. Consequently, in this embodiment, at stage 400 the shutter release button is pressed. At stage 420, the camera 100 acquires or captures the digital photograph. At stage 440, the processor 210 saves the digital photograph into memory 240. Simultaneously to performing stages 400, 420, and 440, the digital camera may implement stages 410, 430, and 450. That is, at stage 410, the camera switches the digital camera 100 to a Sound Recording Mode. At stage 430, the camera records voice annotations of the captured digital photograph from the photographer. At stage 450, the processor 210 saves the digital photograph into memory 240. At stage 460, mapping software 230 links the voice recording to the corresponding digital photograph. The steps illustrated in FIG. 4 are completed before the shutter release button is pressed again to capture the next digital picture by the photographer.

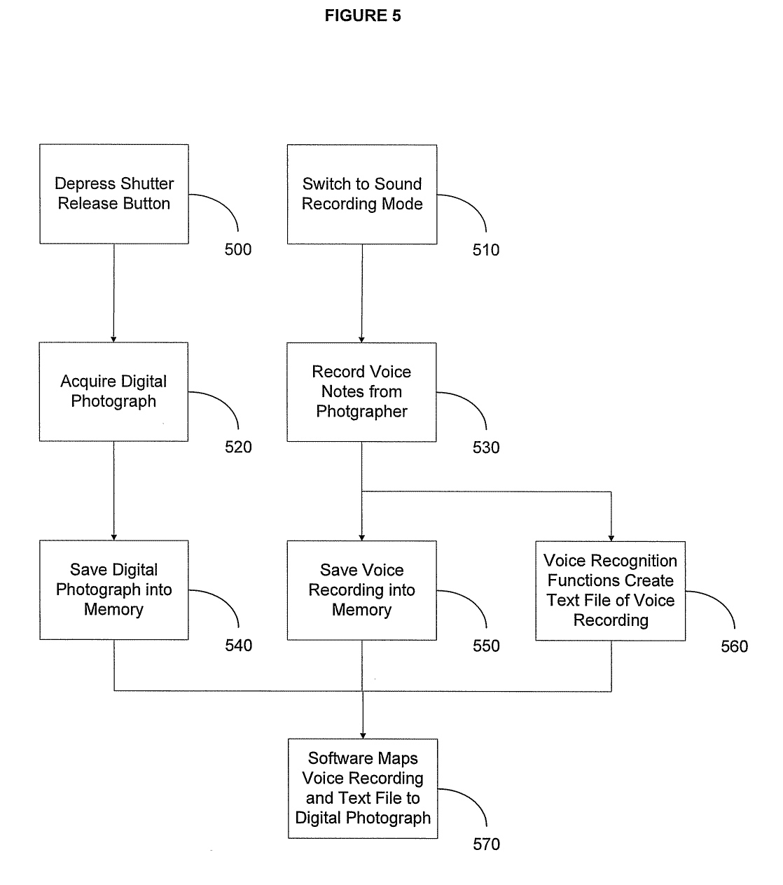

FIG. 5 illustrates an embodiment of the present invention where the voice recognition feature is performed. Similar to FIG. 4, at stage 500, the shutter release button is pressed. At stage 520, the camera 100 acquires or captures the digital photograph. At stage, 540, the processor 210 saves the digital photograph into memory 240. Simultaneously to performing stages 500, 520, and 540, the digital camera may implement stages 510, 530, 550 and 560. That is, at stage 510 switch the digital camera 100 to a Sound Recording Mode. At stage 530, record voice annotations of the captured digital photograph from the photographer. At stage 550, the processor 210 saves the digital photograph into memory 240. At stage 560, voice recognition functions translate the voice recording into text, saving it as a text file. At stage 570, mapping software 230 links the voice recording and the text file to the corresponding digital photograph. The steps illustrated in FIG. 5 are completed before the shutter release button is pressed again to capture the next digital picture by the photographer.

A voice recording may be saved in a variety of formats that may include, but are not limited to, waveform audio format (WAV), audio interchange file format (AIFF), Au file format, Free Lossless Audio Codec (FLAC) file format, Monley's Audio (.APE), WavPack (.WV), MP3, Windows Media Audio (WMA), and Advanced Audio Coding (AAC). Text files may include, but are not limited to, file formats such as Microsoft Word, WordPerfect, plain text, rich text format, web page, etc. The mapping or linking of the voice recording and the text file to the digital photograph may be done in several different ways as would be known by a person skilled in the art. These may include, but are not limited to, embedding the audio and text files within a saved digital photograph file, storing an address pointer to the audio and text files associated with the digital photograph, etc.

After digital photographs with their mapped voice recordings and voice recognition text files are stored into memory 240, they may be downloaded to the memory of computer, personal digital assistant (PDA), or similar viewing device. The voice annotating audio file is played simultaneously when viewing a digital photograph through a computer, PDA, cellular phone, MP3 player, iPod, and DVD player or similar viewing device. Similarly, the voice recognition text file is opened and may be viewed when viewing its corresponding digital photograph.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for annotating a voice recording to a digital photograph, the steps comprising:
switching a digital camera to a sound recording mode;
capturing a digital photograph using the digital camera;
recording voice annotations associated with the digital photograph;
saving the digital photograph into a digital camera memory;
saving the voice annotation recording into a digital camera memory as an audio file; and
mapping the voice annotation recording to the digital photograph.

2. The method according to claim 1, the steps further comprising:
translating the voice annotation recording into text using voice recognition functions;
saving the text into the digital camera memory as a text file; and
mapping the text file to the captured digital photograph.

3. The method according to claim 1, the steps further comprising simultaneously viewing the digital photograph, playing the audio file containing the voice annotation recording, and viewing the text file containing the voice recognition translation of the voice annotation recording.

4. The method according to claim 1, wherein the format of the audio file is selected from the group consisting of a waveform audio format (WAV), audio interchange file format (AIFF), Au file format, Free Lossless Audio Codec (FLAC) file format, Monkey's Audio (.APE), WavPack (.WV), MP3, Windows Media Audio (WMA), and Advanced Audio Coding (AAC).

5. The method according to claim 1, wherein the format of the text file is selected from the group consisting of a Microsoft Word, WordPerfect, plain text, rich text format, and web page.

6. The method according to claim 1, wherein the digital camera memory is of a type selected from the group consisting of SecureDigital (SD), CompactFlash (CF), SONY Memory Stick, xD-Picture Card, USB flash memory drive, SmartMedia, and MiniCard.

7. A computer-readable medium having thereon computer-executable instructions for annotating a voice recording to a digital photograph, the computer-executable instructions comprising:
instructions for switching a digital camera to a sound recording mode;
instructions for capturing a digital photograph using the digital camera;
instructions for recording voice annotations associated with the digital photograph;
instructions for saving the digital photograph into a digital camera memory;
instructions for saving the voice annotation recording into a digital camera memory as an audio file; and
instructions for mapping the voice annotation recording to the digital photograph.

8. The computer-readable medium according to claim 7, the computer-executable instructions further comprising:
instructions for translating the voice annotation recording into text using voice recognition functions;
instructions for saving the text into the digital camera memory as a text file; and
instructions for mapping the text file to the captured digital photograph.

9. The computer-readable medium according to claim 7, the computer-executable instructions further comprising instructions for simultaneously viewing the digital photograph, playing the audio file containing the voice annotation recording, and viewing the text file containing the voice recognition translation of the voice annotation recording.

10. The computer-readable medium according to claim 7, the computer-executable instructions further comprising instructions for selecting the format of the audio file from the group consisting of a waveform audio format (WAV), audio interchange file format (AIFF), Au file format, Free Lossless Audio Codec (FLAC) file format, Monkey's Audio (.APE), WavPack (.WV), MP3, Windows Media Audio (WMA), and Advanced Audio Coding (AAC).

11. The computer-readable medium according to claim 7, the computer-executable instructions further comprising instructions for selecting the format of the text file from the group consisting of a Microsoft Word, WordPerfect, plain text, rich text format, and web page.

12. The computer-readable medium according to claim 7, the computer-executable instructions further comprising instructions for selecting the digital camera memory from the group consisting of a SecureDigital (SD), CompactFlash (CF), SONY Memory Stick, xD-Picture Card, USB flash memory drive, SmartMedia, and MiniCard.

13. A system for annotating a voice recording to a digital photograph comprising:
a digital camera;
a microphone;
a voice recording device;
a switch able to set the digital camera into a sound recording mode;
a digital camera memory capable of saving a digital photograph and an audio file containing a voice recording; and
mapping software to link the voice recording to the digital photograph.

14. The system according to claim 13, further comprising:
a voice recognition software that translates the voice recording into text;
a digital camera memory that saves a digital photograph and a text file containing the translated voice recording; and
mapping software to link the translated voice recording text file to the digital photograph.

15. The system according to claim 13, further comprising a viewing device that is capable of simultaneously viewing the digital photograph, playing the audio file containing the voice annotation recording, and viewing the text file containing the voice recognition translation of the voice annotation recording.

16. The system according to claim 13, wherein the format of the audio file is selected from the group consisting of a waveform audio format (WAV), audio interchange file format (AIFF), Au file format, Free Lossless Audio Codec (FLAC) file format, Monlcey's Audio (.APE), WavPack (Wv), MP3, Windows Media Audio (WMA), and Advanced Audio Coding (AAC).

17. The system according to claim 13, wherein the format of the text file is selected from the group consisting of a Microsoft Word, WordPerfect, plain text, rich text format, and web page.

18. The system according to claim 13, wherein the digital camera memory is of a type selected from the group consisting of SecureDigital (SD), CompactFlash (CF), SONY Memory stick, xD-Picture Card, USB flash memory drive, SmartMedia, and MiniCard.

19. The system according to claim 15, wherein the viewing device is of a type selected from the group consisting of a computer, personal digital assistant (PDA), cellular phone, MP3 player, iPod, and DVD player.

20. The system according to claim 13, wherein the switch is of a type selected from the group consisting of toggle switch, button, and touch screen.
